(19) United States
(12) Patent Application Publication
(10) Pub. No.: US 2025/0017233 A1
(43) Pub. Date: Jan. 16, 2025

(54) PREPARATION METHOD OF TEA ESSENCES PARTICLES

(71) Applicants: Rongfu LV, FUJIAN (CN); Longting MA, FUJIAN (CN)

(72) Inventors: Rongfu LV, FUJIAN (CN); Longting MA, FUJIAN (CN)

(21) Appl. No.: 18/241,213

(22) Filed: Aug. 31, 2023

(30) Foreign Application Priority Data
Jul. 11, 2023 (CN) 202310846676

(51) Int. Cl. A23F 3/18; A23F 3/06; A23F 3/16; A23F 3/20; A23F 3/28; A23F 3/30; A23F 3/36

(52) U.S. Cl. CPC A23F 3/18; A23F 3/06; A23F 3/166; A23F 3/20; A23F 3/28; A23F 3/30; A23F 3/363

(57) ABSTRACT

The present invention relates to the technical field of deep processing of tea, specifically to a preparation method of tea essences particles. The present invention provides a preparation method of tea essences particles, including a process of extraction, filtration and separation, purification and decontamination, activation of activity and improvement of bioavailability, and spray granulation, which enhances activity and bioavailability of the active ingredient of the tea essences, improves taste of the tea essences, and increases the product yield of the tea essences.

### BACKGROUND OF THE INVENTION

The present invention relates to the technical field of deep processing of tea, and specifically relates to a method of preparing tea essences particles.

Tea is one of the world's three traditional beverages, with a variety of functions such as nutrition and health care. The extract of tea contains components such as tea polyphenols, theanine, alkaloids and so on.

Tea polyphenols, theobromine, and caffeine extracted from tea have their individual effect on human health, and how to blend and produce to obtain these several essential components so that they can maximize the benefits of tea to human body, is an urgent pursuit for people. In the prior art, for example, in patent application CN113498861A, a method of making tea essences is published, wherein tea essences particles are obtained by sieving, high temperature and high pressure extraction, membrane filtration, ultra filtration and chromatography such that tea essences particles with blend ratio are obtained through one-time processing, production efficiency is significantly improved when it is compared with a method of obtaining tea polyphenols, tea fucoxanthin, and alkaloid components separately by different processes and then blending them.

In the prior art, a process method for extracting the tea essences particles is provided, including steps of extraction, ceramic membrane filtration, membrane filtration, and acid solution dilution and precipitation, which is a simple production process with lower cost and shorter production cycle, and the tea essences particles obtained have a fruity flavor and a good taste.

The above two process methods of tea essences extraction in the prior art have certain innovations and improvements in the extraction process of tea essences, but there are still technical defects, such as, tea essences purity and yield are low, activity and bioavailability of the active ingredient are low, ratio of each components is not reasonable and the taste is still poor, there is still a need to provide a more advanced tea essences processing technology.

As a result, there is a need for a solution to solve the technical problems existed in the prior art.

### BRIEF SUMMARY OF THE INVENTION

The present invention provides a method of preparing a tea essences particle, which can solve at least part of the problems existed in the prior art.

To solve the above technical problems, according to one aspect of the present invention, the present invention provides the following technical solution:

A method of preparing tea essences particles comprises steps as follows:
Step 1: soaking and extracting dry black tea to obtain tea soup;
Step 2: filtering and separating the tea soup by using a ceramic membrane and a rolled ultra filtration membrane in turn to obtain dialyzed solution and concentrated solution;
Step 3: purifying and precipitating the obtained concentrated solution by using acid precipitation treatment, tannin enzymatic treatment, isoelectric point precipitation, and rolled ultra filtration membrane in turn to obtain concentrated solution;
Step 4: treating the obtained concentrated solution by using alkaline solution and acid solution in turn to obtain tea essences soup solution;
Step 5: spraying and drying the obtained tea essences soup solution to obtain tea essences particles.

As a preferred option of a preparation method of the tea essences particles described in the present invention, wherein step 1 specifically comprises the following steps:
Step 11: taking dry black tea as raw and filtering to remove fine tea powder so as to retain black tea with short strip shape;
Step 12: putting black tea with short strip shape into an extraction tank, injecting distilled water, carrying out soaking treatment under high temperature and high pressure condition, cooling and filtering to obtain tea soup.

As a preferred option of a preparation method of the tea essences particles described in the present invention, wherein step 2 specifically comprises the following steps:
Step 21: carrying out a first-stage dialysis and filtration treatment on the obtained tea soup by using ceramic membrane to obtain first-stage dialyzed solution and first-stage concentrated solution;
Step 22: carrying out a second-stage dialysis and filtration treatment on the obtained first-stage dialyzed solution by using rolled ultra filtration membrane to obtain a second-stage dialyzed solution and a second-stage concentrated solution.

As a preferred option of a preparation method of the tea essences particles described in the present invention, wherein step 3 specifically comprises the following steps:
Step 31: after cooling the second-stage concentrated solution, adding acid solution to adjust pH value, and carrying out pressure filtration treatment by suing nylon filter cloth after standing, to obtain first-stage precipitate and the first-stage supernatant;
Step 32: adding tannin enzyme solution to the first-stage supernatant, standing and enzyme treating;
Step 33: adding alkali solution to enzymatic solution to adjust pH value, and filtering by using nylon filter cloth after standing, to obtain second-stage precipitate and second-stage supernatant;
Step 34: carrying out dialysis and filtration treatment on the second-stage supernatant by using rolled ultra filtration membrane to obtain dialyzed solution and concentrated solution.

As a preferred option of a preparation method of the tea essences particles described in the present invention, wherein step 4 specifically comprises the following steps:
Step 41: adding alkali solution to the concentrated solution to adjust the pH value, and treating under high temperature and high pressure condition after standing, to obtain a soup solution with high activity and high bioavailability;
Step 42: cooling the soup solution to room temperature, adding acid solution to adjust pH value, then adding β-cyclodextrin, and even stirring to obtain tea essences soup solution.

As a preferred option of a preparation method of the tea essences particles described in the present invention, wherein step 5 specifically comprises the following steps: sending tea essences soup solution into a drying tower for spraying and drying treatment, with temperature of air inlet being 80-90° C. and temperature of air outlet being 70-80° C., pulverizing and sieving the particles obtained, and taking 60-100 mesh for granulation, so as to obtain tea essences particles.

As a preferred option of a preparation method of the tea essences particles described in the present invention, wherein mass ratio of dry black tea to distilled water in step 12 is 1: (20-40), soaking temperature is 90-100° C., time is 20-30 min, and cooling temperature is 50-60° C.

As a preferred option of a preparation method of the tea essences particles described in the present invention, wherein pore size of the ceramic membrane in step 21 is 50-120 nm, temperature is 50-70° C., and pressure is 0.15-0.5 MPa, and filtration is terminated when concentration of solids is >12% or filtration flow rate is lower than 60 mL/min;
and/or pore size of the rolled ultra filtration membrane in step 22 is 3000-10000 Dalton, temperature is <50° C., pressure is 1-5 MPa, and filtration is terminated when concentration of solids is >12% or filtration flow rate is lower than 60 mL/min.

As a preferred option of a preparation method of the tea essences particles described in the present invention, wherein cooling temperature in step 31 is 35-40° C., acid solution is a saturated acid solution of citric acid, malic acid, acetic acid or hydrochloric acid, pH value is adjusted to 2-4, standing time is 2-3 h, and pore size of the nylon filter cloth is 200-500 mesh;
concentration of tannin enzyme solution in step 32 is 3-10 g/L, and standing 4-7 hours at normal temperature;
alkali solution in step 33 is a saturated alkali solution of sodium bicarbonate, sodium carbonate or sodium hydroxide, pH value is adjusted to 6.5-7.5, standing time is 30-120 min, and pore size of nylon filter cloth is 200-500 mesh;
pore size of the rolled ultra filtration membrane in step 34 is 3000-10000 Dalton, temperature is <50° C., pressure is 1-5 MPa, and filtration is terminated when concentration of solids is >10% or filtration flow rate is lower than 60 mL/min.

As a preferred option of a preparation method of the tea essences particles described in the present invention, wherein the alkaline solution in step 41 is NaOH solution, pH value is adjusted to 10-14, standing time is 10-30 min, pressure is 0.2-0.3 MPa, temperature is 120-150° C., and treatment time is 2-5 h;
acid solution in step 42 is citric acid, malic acid, acetic acid, tartaric acid or hydrochloric acid solution, pH value is adjusted to 7-8, and β-cyclodextrin is added in an amount of 4-8% of the weight of the soup solution.

The beneficial effects of the present invention are as follows:
1. The present invention enhances activity and bioavailability of the water-soluble functional pigment by treating the water-soluble functional pigment under high temperature, high pressure and alkaline conditions.
2. The present invention reduces combination of tannin and free water-soluble functional pigment through enzymatic of the tannin in the tea soup by tannin enzyme, decreases activity of the water-soluble functional pigment, so as improves purity of the product and degree of bioavailability.
3. The present invention removes a large amount of protein through method of precipitating at isoelectricpoint, so as to improve purity of water-soluble functional pigment in the product.
4. The present invention adjusts acidity of soup solution by acid solution to neutralize the excess alkaline components in the soup solution, so as improves taste of the product. Cyclodextrin has a protective effect on the water-soluble functional pigment, making it free from sunlight, ultraviolet light, oxidation, thermal shock and the like.
5. The present invention uses food-stage malic acid, citric acid, acetic acid and other acidic solvent materials in acid precipitation treatment to improve extraction efficiency of the tea essences, such that tea essences product extracted has fruity flavor, better taste, and is more favor for consumers.
6. The present invention does not use organic solvent for processing in extraction process and dilution precipitation process, such that there is no organic solvent residues, and food safety level is improved.

### DETAILED DESCRIPTION OF THE INVENTION

The technical solutions in the following embodiments will be clearly and completely described in conjunction with the embodiments, and it is obvious that the described embodiments are only a part of the embodiments of the present invention, and not all of the embodiments. Based on the embodiments in the present invention, all other embodiments obtained by a person of normal skill in the art without making creative labor are within the scope of protection of the present invention.

It should be noted that if the embodiments of the present invention involve directional indications (such as up, down, left, right, forward, back . . . ), the directional indications are only used to explain the relative positional relationship, movement condition and the like among the various components in a particular attitude (as shown in the accompanying drawings), and if the particular attitude is changed, the directional indications are also changes accordingly.

Furthermore, if the embodiments of the present invention contain descriptions involving “first”, “second”, etc., the descriptions of “first”, “second”, etc. are used only for descriptive purposes, and are not to be understood as indicating or implying their relative importance or implicitly specifying the number of the indicated technical features. As a result, a feature defined with “first” or “second” may include at least one such feature explicitly or implicitly. In addition, the technical solutions between the various embodiments can be combined with each other, but it must be based on the fact that the person of normal skill in the field can realize it, and when the combination of technical solutions is contradictory or unattainable, it should be considered that the combination of such technical solutions does not exist and is not within the scope of protection of the claims of the present invention.

The present invention provides a method of preparing tea essences particles, which is capable of enhancing activity and bioavailability of the active ingredient of the tea essences, improving taste of the tea essences, and increasing the product yield of the tea essences.

A method of preparing tea essences particles, comprising the following steps:
Step 1: soaking and extracting dry black tea to obtain tea soup;
Step 2: filtering and separating the tea soup by using a ceramic membrane and a rolled ultra filtration membrane in turn to obtain dialyzed solution and concentrated solution;
Step 3: purifying and precipitating the obtained concentrated solution by using acid precipitation treatment, tannin enzymatic treatment, isoelectric point precipitation, and rolled ultra filtration membrane in turn to obtain concentrated solution;
Step 4: treating the obtained concentrated solution by using alkaline solution and acid solution in turn to obtain tea essences soup solution;
Step 5: spraying and drying the obtained tea essences soup solution to obtain tea essences particles.

Preferably, step 1 specifically comprises the following steps:
Step 11: taking dry black tea as raw and filtering to remove fine tea powder so as to retain black tea with short strip shape;
Step 12: putting black tea with short strip shape into extraction tank, injecting distilled water, carrying out soaking treatment under high temperature and high pressure condition, cooling and filtering to obtain tea soup.

Preferably, mass ratio of dry black tea to distilled water in step 12 is 1: (20-40), soaking temperature is 90-100° C., time is 20-30 min, and cooling temperature is 50-60° C.

Preferably, step 2 specifically comprises the following steps:
Step 21: carrying out a first-stage dialysis and filtration treatment on the obtained tea soup by using ceramic membrane to obtain first-stage dialyzed solution and first-stage concentrated solution.
Step 22: carrying out a second-stage dialysis and filtration treatment on the obtained first-stage dialyzed solution by using rolled ultra filtration membrane to obtain a second-stage dialyzed solution and a second-stage concentrated solution.

Preferably, pore size of the ceramic membrane in step 21 is 50-120 nm, temperature is 50-70° C., pressure is 0.15-0.5 MPa, and filtration is terminated when concentration of solids is >12% or filtration flow rate is lower than 60 mL/min.

Preferably, pore size of the rolled ultra filtration membrane in step 22 is 3000-10000 Dalton, temperature is <50° C., pressure is 1-5 MPa, and filtration is terminated when concentration of solids is >12% or filtration flow rate is lower than 60 mL/min.

The purpose of ceramic membrane dialysis and filtration treatment is mainly to remove large-size and macromolecular substances such as fiber particles and proteins with ultra-large molecular weight in tea. The purpose of rolled ultra filtration membrane dialysis and filtration treatment is mainly to remove excess water and small molecular weight compounds, such as tea polyphenols, amino acids, small molecule sugars, alkaloids, tea saponins, aromatic substances and vitamins.

Preferably, step 3 specifically includes the following steps:
Step 31: after cooling the second-stage concentrated solution, adding acid solution to adjust pH value, and carrying out pressure filtration treatment by suing nylon filter cloth after standing, to obtain first-stage precipitate and the first-stage supernatant.

The acid precipitation treatment is a first-stage precipitation treatment, and is mainly aimed to remove large molecules of acidic protein.

Step 32: adding tannin enzyme solution to the first-stage supernatant, standing and enzyme treating to obtain enzymatic solution.

Tannin enzymatic treatment is second-stage impurity removal treatment, and is mainly aimed to remove tannin substances and large molecules tannin protein compounds, so as to prevent combination of the tannins and the free water-soluble functional pigments subsequently separated.

Step 33: Adding alkali solution to the second-stage enzymatic solution to adjust pH value, and filtering by using nylon filter cloth after standing, to obtain third-stage precipitate and third-stage supernatant.

The salting-out treatment is third-stage sedimentation, and is mainly aimed to remove large molecule neutral proteins.

Step 34: carrying out dialysis and filtration treatment on the third-stage supernatant by using rolled ultra filtration membrane to obtain dialyzed solution and concentrated solution.

The main purpose of the dialysis and filtration treatment with the rolled ultra filtration membrane is to carry out concentration to remove excess water.

Preferably, cooling temperature in step 31 is 35-40° C., acid solution is a saturated acid solution of citric acid, malic acid, acetic acid or hydrochloric acid, pH value is adjusted to 2-4, standing time is 2-3 h, and pore size of the nylon filter cloth is 200-500 mesh;

Preferably, concentration of tannin enzyme solution in step 32 is 3-10 g/L, and standing and enzyme treating for 4-7 hours at normal temperature;

Preferably, alkali solution in step 33 is a saturated alkali solution of sodium bicarbonate, sodium carbonate or sodium hydroxide, pH value is adjusted to 6.5-7.5, standing time is 30-120 min, and pore size of nylon filter cloth is 200-500 mesh;

Preferably, pore size of the rolled ultra filtration membrane in step 34 is 3000-10000 Dalton, temperature is <50° C., pressure is 1-5 MPa, and filtration is terminated when concentration of solids is >10% or filtration flow rate is lower than 60 mL/min.

Preferably, step 4 specifically comprises the following steps:

Step 41: Adding alkali solution to the concentrated solution to adjust the pH value, and treating under high temperature and high pressure condition after standing, to obtain a soup solution with high activity and high bioavailability.

Under normal conditions, the water-soluble functional pigments (theaflavin, thearubigin and theaflavin) and tea polysaccharides in the black tea soup solution exist in the form of glycosides, with larger molecules, low bioactivity and low bioavailability. High-temperature, high-pressure, alkaline conditions treatment can make the aldehyde group in polysaccharides undergo the Cannizzaro reaction to generate sugar sodium salt, and functional pigments become small molecules biological active substances in the form of free-state, to improve activity and bioavailability of water-soluble functional pigments.

Step 42: Cooling the soup solution to room temperature, adding acid solution to adjust pH value, then adding β-cyclodextrin, and even stirring to obtain tea essences soup solution.

Adjusting pH value by acid solution to neutralize and remove the excess alkali in the soup liquor, thereby improving the taste and flavor of the tea essences.

Preferably, alkaline solution in step 41 is NaOH solution, pH value is adjusted to 10-14, standing time is 10-30 min, pressure is 0.2-0.3 MPa, temperature is 120-150° C., and treatment time is 2-5 h.

Preferably, acid solution in step 42 is citric acid, malic acid, acetic acid, tartaric acid or hydrochloric acid solution, pH value is adjusted to 7-8, and β-cyclodextrin is added in an amount of 4-8% of the weight of the soup solution.

Preferably, step 5 specifically comprises the following steps: sending tea essences soup solution into a drying tower for spraying and drying treatment, with temperature of air inlet being 80-90° C. and temperature of air outlet being 70-80° C., pulverizing and sieving the particles obtained, and taking 60-100 mesh for granulation, so as to obtain tea essences particles.

### Embodiment 1

A method for preparation of tea essences particles comprises specific extraction and preparation steps as follows:

### (I) Extraction Treatment

Taking 1000 g of Ceylon black tea as raw and filtering to remove fine tea powder so as to retain black tea with short strip shape;

Putting black tea with short strip shape into extraction tank, injecting distilled water according to mass ratio of black tea to distilled water of 1:30, carrying out the soaking treatment under high temperature and high pressure condition at a temperature of 90° C. for 30 min, cooling down to 50° C. and filtering to obtain tea soup.

### (II) Filtration and Separation Treatment

Putting tea soup obtained in ceramic membrane recycling tank for primary dialysis and filtration treatment, with pore size of the ceramic membrane being 80 nm, temperature being 60° C., pressure being 0.3 MPa, and filtration being terminated when concentration of solids is >12%, to obtain first-stage dialyzed solution and first-stage concentrated solution;

Putting first-stage dialyzed solution obtained in rolled ultra filtration membrane for secondary dialysis and filtration treatment, with pore size of the rolled ultra filtration membrane being 7000 Daltons, temperature being 40° C., pressure being 3 MPa, and filtration being terminated when concentration of solids is >12%, to obtain second-stage dialyzed solution and second-stage concentrated solution.

### (III) Purification and Decontamination Treatment

Cooling the second-stage concentrated solution obtained to 40° C., adding saturated citric acid solution to adjust pH value of tea soup solution concentrated to be 3, after standing for 2 h, carrying out press filtration treatment by using a nylon filter cloth with pore size of 400 mesh, to obtain first-stage precipitate and first-stage supernatant;

Adding 5 g/L tannin enzyme solution 10 mL to the first-stage supernatant obtained, standing at normal temperature for 4 hours, to obtain enzymatic solution;

Adding saturated sodium hydroxide solution to the enzymatic solution obtained to adjust pH value to 7.0, standing for 60 min, and filtering by using nylon filter cloth with 400-mesh, to obtain second-stage precipitate and second-stage supernatant;

Transferring second-stage supernatant obtained to rolled ultra filtration membrane for carrying out dialysis and filtration treatment, with pore size of rolled ultra filtration membrane being 7000 Daltons, temperature being 40° C., and pressure being 3 MPa, and filtration being terminated when concentration of solids is >12%, to obtain third-stage dialyzed solution and third-stage concentrated solution.

### (IV) Activation of Activity and Improvement of Bioavailability

Adding sodium hydroxide solution to the third-stage concentrated solution to adjust pH value to 12, standing for 20 min, and then keeping under the condition of 0.2 MPa pressure and 130° C. temperature for 4 h, to obtain soup solution with high activity and high bioavailability; Cooling the soup solution with high bioavailability to normal temperature, adding saturated citric acid solution to adjust pH value to 7.0, adding 6 wt % weight β-cyclodextrin and even stirring, to obtain tea essences soup solution.

### (V) Spraying and Drying Granulation

Sending tea essences soup solution into drying tower for spraying and drying treatment, with temperature of the air inlet being 90° C. and temperature of the air outlet being 80° C., pulverizing and sieving the particles obtained, and taking 80 mesh for granulation, so as to obtain tea essences particles, and by weighing, the weight of tea essences particles obtained is 34.8 g.

### Embodiment 2

A method for preparation of tea essences particles comprises specific extraction and preparation steps as follows:

### (I) Extraction Treatment

Taking 1000 g of Ceylon black tea as raw and filtering to remove fine tea powder so as to retain black tea with short strip shape;

Putting black tea with short strip shape into extraction tank, injecting distilled water according to mass ratio of black tea to distilled water of 1:40, carrying out the soaking treatment under high temperature and high pressure condition at a temperature of 100° C. for 25 min, cooling down to 55° C. and filtering to obtain tea soup.

### (II) Filtration and Separation Treatment

Putting tea soup obtained in ceramic membrane recycling tank for primary dialysis and filtration treatment, with pore size of the ceramic membrane being 60 nm, temperature being 70° C., pressure being 0.4 MPa, and filtration being terminated when concentration of solids is >12%, to obtain first-stage dialyzed solution and first-stage concentrated solution;

Putting first-stage dialyzed solution obtained in rolled ultra filtration membrane for secondary dialysis and filtration treatment, with pore size of the rolled ultra filtration membrane being 4000 Daltons, temperature being 40° C., pressure being 5 MPa, and filtration being terminated when concentration of solids is >12%, to obtain second-stage dialyzed solution and second-stage concentrated solution.

### (III) Purification and Decontamination Treatment

Cooling the second-stage concentrated solution obtained to 35° C., adding saturated malic acid solution to adjust pH value of tea soup solution concentrated to be 3.5, after standing for 3 h, carrying out press filtration treatment by using a nylon filter cloth with pore size of 300 mesh, to obtain first-stage precipitate and first-stage supernatant;

Adding 8 g/L tannin enzyme solution 8 mL to the first-stage supernatant obtained, standing at room temperature for 5 hours, to obtain enzymatic solution;

Adding saturated sodium carbonate solution to the enzymatic solution obtained to adjust pH value to 7.2, standing for 80 min, and filtering by using nylon filter cloth with 300-mesh, to obtain second-stage precipitate and second-stage supernatant;

Transferring second-stage supernatant obtained to rolled ultra filtration membrane for carrying out dialysis and filtration treatment, with pore size of rolled ultra filtration membrane being 4000 Daltons, temperature being 40° C., pressure being 5 MPa, and filtration being terminated when concentration of solids is >12%, to obtain third-stage dialyzed solution and third-stage concentrated solution.

### (IV) Activation of Activity and Improvement of Bioavailability

Adding sodium hydroxide solution to the third-stage concentrated solution to adjust pH value to 11, standing for 30 min, and then keeping under the condition of 0.3 MPa pressure and 120° C. temperature for 3 h, to obtain soup solution with high activity and high bioavailability; Cooling the soup solution with high bioavailability to normal temperature, adding saturated citric acid solution to adjust pH value to 7.5, adding 5wt % weight β-cyclodextrin and even stirring, to obtain tea essences soup solution.

### (V) Spraying and Drying Granulation

Sending tea essences soup solution into drying tower for spraying and drying treatment, with temperature of the air inlet being 80° C. and temperature of the air outlet being 70° C., pulverizing and sieving the particles obtained, and taking 70 mesh for granulation, so as to obtain tea essences particles, and by weighing, the weight of tea essences particles obtained is 36.4 g.

### Embodiment 3

A method for preparation of tea essences particles comprises specific extraction and preparation steps as follows:

### (I) Extraction Treatment

Taking 1000 g of Ceylon black tea as raw and filtering to remove fine tea powder so as to retain black tea with short strip shape;

Putting black tea with short strip shape into extraction tank, injecting distilled water according to mass ratio of black tea to distilled water of 1:25, carrying out the soaking treatment under high temperature and high pressure condition at a temperature of 90° C. for 30 min, cooling down to 50° C. and filtering to obtain tea soup.

### (II) Filtration and Separation Treatment

Putting tea soup obtained in ceramic membrane recycling tank for primary dialysis and filtration treatment, with pore size of the ceramic membrane being 120 nm, temperature being 60° C., pressure being 0.25 MPa, and filtration being terminated when concentration of solids is >12%, to obtain first-stage dialyzed solution and first-stage concentrated solution;

Putting first-stage dialyzed solution obtained in rolled ultra filtration membrane for secondary dialysis and filtration treatment, with pore size of the rolled ultra filtration membrane being 9000 Daltons, temperature being 50° C., pressure being 5 MPa, and filtration being terminated when concentration of solids is >12%, to obtain second-stage dialyzed solution and second-stage concentrated solution.

### (III) Purification and Decontamination Treatment

Cooling the second-stage concentrated solution obtained to 40° C., adding saturated tartaric acid solution to adjust pH value of tea soup solution concentrated to be 2.0, after standing for 2.5 h, carrying out press filtration treatment by using a nylon filter cloth with pore size of 500 mesh, to obtain first-stage precipitate and first-stage supernatant;

Adding 4 g/L tannin enzyme solution 18 mL to the first-stage supernatant obtained, standing at room temperature for 6 hours, to obtain enzymatic solution;

Adding saturated sodium carbonate solution to the enzymatic solution obtained to adjust pH value to 6.8, standing for 90 min, and filtering by using nylon filter cloth with 500-mesh, to obtain second-stage precipitate and second-stage supernatant;

Transferring second-stage supernatant obtained to rolled ultra filtration membrane for carrying out dialysis and filtration treatment, with pore size of rolled ultra filtration membrane being 9000 Daltons, temperature being 50° C., and pressure being 4 MPa, and filtration being terminated when concentration of solids is >12%, to obtain third-stage dialyzed solution and third-stage concentrated solution.

### (IV) Activation of Activity and Improvement of Bioavailability

Adding sodium hydroxide solution to the third-stage concentrated solution to adjust pH value to 13, standing for 35 min, and then keeping under the condition of 0.3 MPa pressure and 140° C. temperature for 4 h, to obtain soup solution with high activity and high bioavailability; Cooling the soup solution with high bioavailability to normal temperature, adding saturated tartaric acid solution to adjust pH value to 8.0, adding 6 wt % weight β-cyclodextrin and even stirring, to obtain tea essences soup solution.

### (V) Spraying and Drying Granulation

Sending tea essences soup solution into drying tower for spraying and drying treatment, with temperature of the air inlet being 85° C. and temperature of the air outlet being 75° C., pulverizing and sieving the particles obtained, and taking 70 mesh for granulation, so as to obtain tea essences particles, and by weighing, the weight of tea essences particles obtained is 37.2 g.

The above is only a preferred embodiment of the present invention, and is not intended to limit the patent scope of the present invention, and any equivalent structural transformations made under the inventive concept of the present invention using the contents of the specification of the present invention or directly/indirectly utilized in other related fields of technology are included in the scope of patent protection of the present invention.

What is claimed is:

1. A method of preparing tea essences particles, characterized in that, comprising steps as follows:
Step 1: soaking and extracting dry black tea to obtain tea soup;
Step 2: filtering and separating the tea soup by using a ceramic membrane and a rolled ultra filtration membrane in turn to obtain dialyzed solution and concentrated solution;
Step 3: purifying and precipitating the obtained concentrated solution by using acid precipitation treatment, tannin enzymatic treatment, isoelectric point precipitation, and rolled ultra filtration membrane in turn to obtain concentrated solution;
Step 4: treating the obtained concentrated solution by using alkaline solution and acid solution in turn to obtain tea essences soup solution;
Step 5: spraying and drying the obtained tea essences soup solution to obtain tea essences particles.

2. A method of preparing tea essences particles according to claim 1, characterized in that, step 1 specifically comprises the following steps:
Step 11: taking dry black tea as raw and filtering to remove fine tea powder so as to retain black tea with short strip shape;
Step 12: putting black tea with short strip shape into extraction tank, injecting distilled water, carrying out soaking treatment under high temperature and high pressure condition, cooling and filtering to obtain tea soup.

3. A method of preparing tea essences particles according to claim 2, characterized in that, step 2 specifically comprises the following steps:
Step 21: carrying out a first-stage dialysis and filtration treatment on the obtained tea soup by using ceramic membrane to obtain first-stage dialyzed solution and first-stage concentrated solution;
Step 22: carrying out a second-stage dialysis and filtration treatment on the obtained first-stage dialyzed solution by using rolled ultra filtration membrane to obtain second-stage dialyzed solution and second-stage concentrated solution.

4. A method of preparing tea essences particles according to claim 3, characterized in that, step 3 specifically comprises the following steps:
Step 31: after cooling the second-stage concentrated solution, adding acid solution to adjust pH value, and carrying out pressure filtration treatment by suing nylon filter cloth after standing, to obtain first-stage precipitate and the first-stage supernatant;
Step 32: adding tannin enzyme solution to the first-stage supernatant, standing and enzyme treating;
Step 33: adding alkali solution into enzymatic solution to adjust pH value, and filtering by using nylon filter cloth after standing, to obtain second-stage precipitate and second-stage supernatant;
Step 34: carrying out dialysis and filtration treatment on the second-stage supernatant by using rolled ultra filtration membrane to obtain dialyzed solution and concentrated solution.

5. A method of preparing tea essences particles according to claim 4, characterized in that, step 4 specifically comprises the following steps:
Step 41: adding alkali solution to the concentrated solution to adjust the pH value, and treating under high temperature and high pressure condition after standing, to obtain a soup solution with high activity and high bioavailability;
Step 42: cooling the soup solution to room temperature, adding acid solution to adjust pH value, then adding β-cyclodextrin, and even stirring to obtain tea essences soup solution.

6. A method of preparing tea essences particles according to claim 5, characterized in that, step 5 specifically comprises the following steps: sending tea essences soup solution into a drying tower for spraying and drying treatment, with temperature of air inlet being 80-90° C. and temperature of air outlet being 70-80° C., pulverizing and sieving the particles obtained, and taking 60-100 mesh for granulation, so as to obtain tea essences particles.

7. A method of preparing tea essences particles according to claim 2, characterized in that, mass ratio of dry black tea to distilled water in step 12 is 1: (20-40), soaking temperature is 90-100° C., time is 20-30 min, and cooling temperature is 50-60° C.

8. A method of preparing tea essences particles according to claim 3, characterized in that, pore size of the ceramic membrane in step 21 is 50-120 nm, temperature is 50-70° C., pressure is 0.15-0.5 MPa, and filtration is terminated when concentration of solids is >12% or filtration flow rate is lower than 60 mL/min;
and/or pore size of the rolled ultra filtration membrane in step 22 is 3000-10000 Dalton, temperature is <50° C., pressure is 1-5 MPa, and filtration is terminated when concentration of solids is >12% or filtration flow rate is lower than 60 mL/min.

9. A method of preparing tea essences particles according to claim 4, characterized in that, cooling temperature in step 31 is 35-40° C., acid solution is a saturated acid solution of citric acid, malic acid, acetic acid or hydrochloric acid, pH value is adjusted to 2-4, standing time is 2-3 h, and pore size of the nylon filter cloth is 200-500 mesh;
concentration of tannin enzyme solution in step 32 is 3-10 g/L, and standing and enzyme treating for 4-7 hours at normal temperature;
alkali solution in step 33 is a saturated alkali solution of sodium bicarbonate, sodium carbonate or sodium hydroxide, pH value is adjusted to 6.5-7.5, standing time is 30-120 min, and pore size of the nylon filter cloth is 200-500 mesh;
pore size of the rolled ultra filtration membrane in step 34 is 3000-10000 Dalton, temperature is <50° C., and pressure is 1-5 MPa, filtration is terminated when concentration of solids is >10% or filtration flow rate is lower than 60 mL/min.

10. A method of preparing tea essences particles according to claim 5, characterized in that, the alkaline solution in step 41 is NaOH solution, pH value is adjusted to 10-14, standing time is 10-30 min, pressure is 0.2-0.3 MPa, temperature is 120-150° C., and treatment time is 2-5 h;
acid solution in step 42 is citric acid, malic acid, acetic acid, tartaric acid or hydrochloric acid solution, pH value is adjusted to 7-8, and β-cyclodextrin is added in an amount of 4-8% of the weight of the soup solution.
